(19) United States
(12) Patent Application Publication
(10) Pub. No.: US 2012/0091380 A1
(43) Pub. Date: Apr. 19, 2012

(54) Combination Valve Assembly

(75) Inventors: Shmuel Dovid Newman, Redondo Beach, CA (US); Jeffrey O. Brown, North Logan, UT (US); David Kostka, San Pedro, CA (US); Bernardo Herzer, Los Angeles, CA (US)

(73) Assignee: DAAS IP Management, LLC, Gardena, CA (US)

(21) Appl. No.: 13/272,193

(22) Filed: Oct. 12, 2011

Related U.S. Application Data
(63) Continuation-in-part of application No. 12/776,267, filed on May 7, 2010.
(60) Provisional application No. 61/392,421, filed on Oct. 12, 2010.

(51) Int. Cl. F16K 1/00

(52) U.S. Cl. 251/324

(57) ABSTRACT

A combination valve assembly is adapted to being an interface for filling and relieving excess pressure from a closed fluid system such as a propane tank, and to enable the regulation of fluid height within the closed fluid system via a dip tube and a bleeder set screw. The system generally comprises a pin valve element, an insert shell element, a main housing element, a relief system, and a dip tube member in fluid communication with an overfill port in the main housing. The dip tube member may be adapted to extend outward of the distal end of the man housing element.

### RELATED APPLICATIONS

This application is a continuation-in-part of U.S. nonprovisional application Ser. No. 12/776,267 filed May 7, 2010 which claims the benefit of U.S. Provisional Application No. 61/215,726 filed May 8, 2009, the contents of each of which are incorporated by this reference in their entirety for all purposes as if fully set forth herein. This application also claims the benefit of U.S. provisional application No. 61/392,421, filed Oct. 12, 2010, the content of which is also incorporated by this reference in its entirety for all purposes as if fully set forth herein.

### TECHNICAL FIELD

The present invention relates generally to valve assemblies for association with enclosed pressurized fluid storage reservoirs, particularly those valve assemblies which may act as an interface through which the pressurized fluid reservoir may be filled, automatically relieved of over pressurization, and relieved of liquid which has exceeded a predetermined fill point within the reservoir.

### BACKGROUND

Safe operation of pressurized closed fluid systems requires a careful balance between maintaining the necessary pressure or fluid density to support the application of the system and avoiding exceeding the structural limitations of the system. This balance becomes particularly important when the system is designed for use by average consumers who may not be aware of how to avoid overfilling such a system or understand the risks posed by exceeding the pressure limitations of the system. Examples of such pressurized closed fluid systems include small tanks used to supply pressurized gas to recreational paintball markers and tanks used to store pressurized propane.

The combination of fill and relief valves in a single housing is known. U.S. Pat. No. 3,747,626, the disclosure of which is hereby incorporated by reference as if fully set forth herein, teaches, in part, a combined fill and relief valve wherein the fill valve is biased toward an open position. However, this kind of system does not appear to teach or suggest use as a fill valve where the inlet side is typically left exposed to ambient pressure.

U.S. Pat. No. 6,079,519, the disclosure of which is hereby incorporated by reference as if fully set forth herein, appears to teach, in part, a fill and relief valve with a grease fitting on the inlet side of the valve and a required chamber relief bore disposed between the valve's transverse relief port and the atmosphere in order to vent overpressurized grease to the atmosphere. The apparent resulting additional relief bore length substantially increases susceptibility to clogging of the pressure relieving feature of the valve.

U.S. Pat. No. 5,694,969, the disclosure of which is hereby incorporated by reference as if fully set forth herein, teaches a pressure relief tire valve with independent input and overpressure valves axially aligned with each other. However, the mechanism appears to require the forming or machining of longitudinal grooves along the inner wall of the chamber to allow pressurized fluid to flow around the overpressure valve portion of the mechanism, thereby adding cost and complexity to the manufacturing of the mechanism.

U.S. Pat. No. 7,073,527, the disclosure of which is hereby incorporated by reference as if fully set forth herein, teaches, in part, an apparatus for regulating the internal pressure of a closed system, comprising concentrically aligned intake and release valves. However, as illustrated by the drawings of the disclosure, the mechanism comprises a setting nut which appears to require the tapping of partially hidden threading. Such a machining operation can add significant cost and complexity to the manufacturing of such an apparatus.

Accordingly, there exists a need for a fill and relief valve assembly which is reliable and inexpensive to manufacture, establishes and maintains a fluid seal between the pressurized closed fluid system and the ambient pressure environment when a fill source nozzle is removed from the input side of the valve, and avoids relief port clogging while minimizing the radial diameter of the valve. There is a need for the combination of these features in one valve assembly.

### SUMMARY

By way of summary, the embodiments concern a combination valve assembly adapted to being an interface for filling and relieving excess pressure from a closed fluid system. The combination valve assembly generally comprises a pin valve element, an insert shell element, a main housing element and a relief system. Embodiments of a combination valve assembly may be adapted to being mounted in a port in a pressure tank, for example, a propane tank.

A pin valve element may include a pin valve body and a piston member. The piston member may be adapted to be slidably retained within the pin valve body. The pin valve element may have an open configuration and a closed configuration. The pin valve element is generally elastically biased toward its closed configuration. The elastic bias may be overcome responsive to a predetermined level of mechanical force axially applied to the piston member

An insert shell element may have an inner bore extending therethrough, The inner bore may be adapted to threadedly receive the pin valve body. A main housing element may have a main bore adapted to receivingly engage the insert shell element so as to form an annular relief chamber. The main housing element may have a proximal end, a distal end and a relief port therebetween. The relief port may be adapted to be in fluid communication between the annular relief chamber and the ambient environment. In particular embodiments, the relief port extends generally radially outwardly of the main bore.

A relief valve system may have a relief configuration, a sealed configuration, the distal end adapted to being in fluid communication with the annular relief chamber when the relief valve system is in its relief configuration. The relief valve system may be resiliently biased toward its sealed configuration. The resilient bias may be overcome responsive to a predetermined pressure at the distal end.

In exemplary embodiments, the main housing member may further have an overfill channel and an overfill port. The overfill channel may be in fluid communication between the distal end and the overfill port. The overfill port may be adapted to be in fluid communication between the overfill channel and the ambient environment. In particular such embodiments, the main housing element includes an outer surface, and the overfill port extends through the outer surface. In further such embodiments, the overfill port may be adapted to threadedly engage a bleeder set screw. In additional such embodiments, the relief port and the overfill port maybe at approximately the same axial position along the main housing member. In certain embodiments with an overfill channel, the overfill channel may be adapted to engage a dip tube member such that the dip tube member extends generally outward of the distal end.

### BRIEF DESCRIPTION OF THE DRAWINGS

Further advantages of the present invention may become apparent to those skilled in the art with the benefit of the following detailed description of the preferred embodiments and upon reference to the accompanying drawings in which:

FIG. 1 is a diagrammatic perspective view of a combination valve assembly;

FIG. 2 is a diagrammatic exploded view of the embodiment illustrated in FIG. 1;

FIG. 3 is a diagrammatic perspective view of a main housing element, such as the one used in the embodiment of FIG. 1;

FIG. 4 is a side view of the main housing element of FIG. 3;

FIG. 5 is a side further view of the main housing element of FIG. 3, but oriented 90 degrees relative to the view of FIG. 4;

FIG. 6 is a side further view of the main housing element of FIG. 3, but oriented 180 degrees relative to the view of FIG. 4 and 90 degrees from the view of FIG. 5;

FIG. 7 is a diagrammatic cross-sectional view taken along line 7-7 in FIG. 5;

FIG. 8 is a diagrammatic cross-sectional view taken along line 8-8 in FIG. 5;

FIG. 9 is a diagrammatic cross-sectional view taken along line 9-9 in FIG. 5;

FIG. 10 is a diagrammatic side view of an insert shell element, such as the one used in the embodiment of FIG. 1;

FIG. 11 is a diagrammatic cross-sectional view taken along line 11-11 in FIG. 10;

FIG. 12 is a diagrammatic side view of a fill valve element, such as the one used in the embodiment of FIG. 1;

FIG. 13 is a further side view of the fill valve element of FIG. 12, but oriented 90 degrees relative to the view of FIG. 12;

FIG. 14 is a diagrammatic side view of a relief plunger member, such as the one used in the embodiment of FIG. 1;

FIG. 15 is a diagrammatic perspective view of the relief plunger member of FIG. 14;

FIG. 16 is a diagrammatic side view of the embodiment of FIG. 1;

FIG. 17 is a diagrammatic cross-sectional view taken along line 17-17 in FIG. 16;

FIG. 18 is a diagrammatic cross-sectional view taken along line 18-18 in FIG. 16, in which the pin valve element is in its open configuration, allowing fluid to flow through the pin valve element; and

FIG. 19 is a diagrammatic cross-sectional view taken along line 18-18 in FIG. 16, in which the pin valve element is in its closed configuration, thereby preventing fluid from flowing through the pin valve element, and the relief valve system is in its relief configuration, thereby allowing excessively pressurized fluid within the reservoir to escape.

### DETAILED DESCRIPTION OF THE PREFERRED EMBODIMENTS

Referring now to the drawings, like reference numerals designate identical or corresponding features throughout the several views.

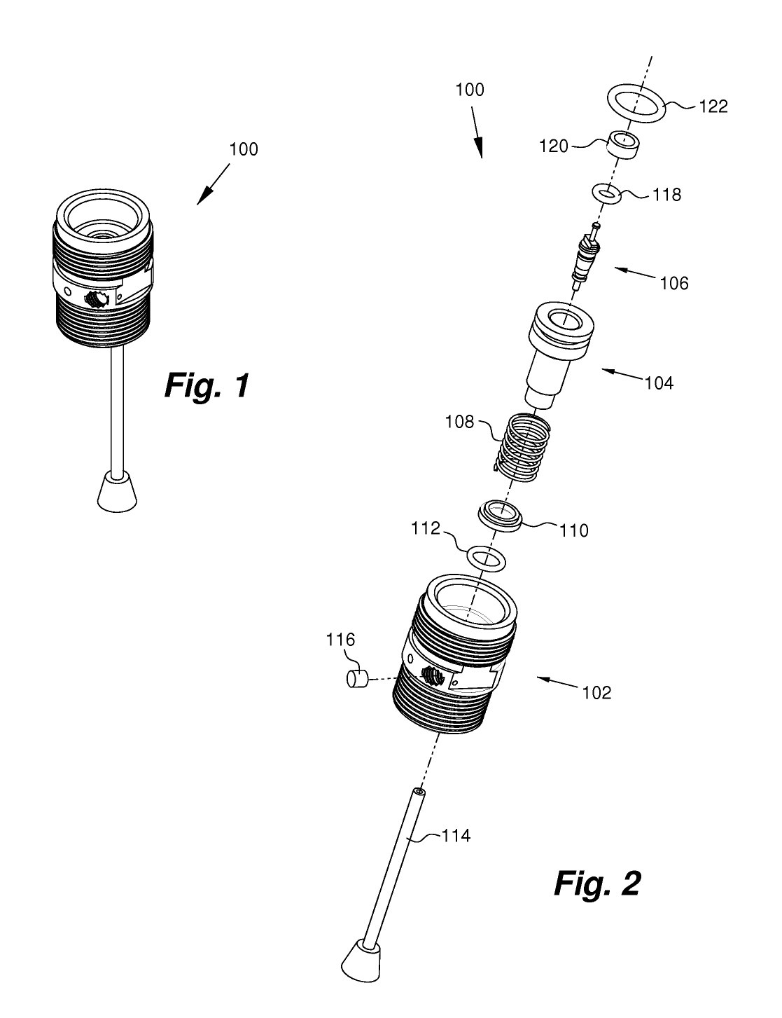

Referring to FIGS. 1 and 2, embodiments of a combination valve assembly 100 are adapted to being mounted in a port in a pressure tank (not shown). The combination valve assembly 100 generally comprises a pin valve element 106, an insert shell 104, a main housing element 102 and a relief valve system. Further embodiments may comprise a dip tube member 114. Embodiments may further include a probe o-ring 118 held in place by a detent ring 120

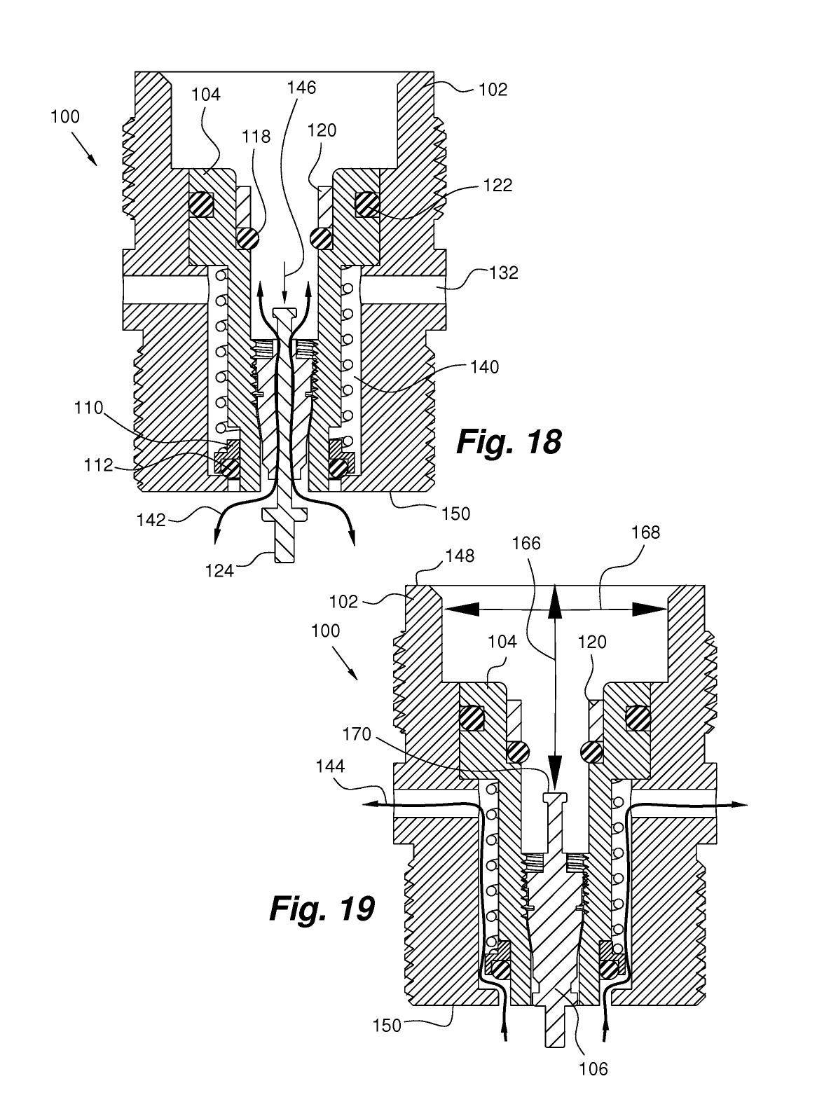

Referring to FIGS. 12 and 13 for example, the pin valve element 106 generally includes a pin valve body 126 and a piston member 124. The piston member 124 has an inlet end 170 and is typically adapted to be slidably retained within the pin valve body 126. The pin valve body may have a first end 128 and a second end 130. The pin valve element 106 will commonly take the form of a Schrader-type valve. The pin valve element 106 has an open configuration (see, for example, FIG. 18) and a closed configuration (see, for example, FIG. 19). FIG. 18 illustrates a pin valve flow path 142 which may allow fluid to pass in either direction through the pin valve element when the pin valve element is in its open configuration. The pin valve element 106 is elastically biased toward its closed configuration, generally by way of a valve spring (not shown) within the pin valve element 106. The elastic bias is overcome responsive to a predetermined level of mechanical force axially applied to the piston member 124, at, for example, the inlet end 170, in an axial direction 146.

The insert shell element 104 has an inner bore 160 extending therethrough. The inner bore 160 may be adapted to threadedly receive the pin valve body 126. An additional seal can be formed between the insert shell element 104 and the main housing member 102 by way of an insert o-ring 122.

The main housing element 102 has a main bore 152 adapted to receivingly engage the insert shell element 104 so as to form an annular relief chamber 140. The main housing element 102 has a proximal end 148, a distal end 150 and a relief port 132 therebetween. The relief port 132 may be adapted to be in fluid communication between the annular relief chamber 140 and the ambient environment. Referring in particular to FIG. 4, the main housing element 102 typically has a proximal portion 154, a distal portion 156, and an intermediate portion 158. The distal portion 156 may include threading to threadedly engage the pressure tank. The main housing element 102 may also include one or more tool engagement features 164, which may be used in cooperation with a standard torquing tool to tighten the main housing member 102 to the pressure tank. The proximal portion 154 may also include threading for threadedly engaging an attachment associated with either a fill source or an application for pressurized fluid.

A relief valve system generally includes a relief plunger member 110, a pressure relief o-ring 112 and a pressure relief spring 108, each of which are generally retain within the annular relief chamber 140. As illustrated in FIGS. 18 and 19, for example, the pressure relief o-ring may be seated within the relief plunger member 110. The relief plunger member 110 may be axially biased toward the distal end 150 of the main housing member 102, typically by way of pressure relief spring 108. The relief valve system generally includes a relief configuration (see, for example, FIG. 19) and a sealed configuration (see, for example, FIG. 18). The distal end 150 is adapted to being in fluid communication with the annular relief chamber 140 when the relief valve system is in its relief configuration, as illustrated, for example, by the relief valve flow path 144. The relief valve system is resiliently biased toward its sealed configuration. The resilient bias is adapted to be overcome responsive to a predetermined pressure at the distal end 150.

Referring to FIG. 8, in certain embodiments, the relief port 132 may extend generally radially outwardly of the main bore 152. There may be one or more such relief ports 132.

In particular embodiments, the main housing member 102 further includes an overfill channel 138 and an overfill port 136. The overfill channel 138 may be in fluid communication between the distal end 150 and the overfill port 136. The overfill port 136 may be adapted to be in fluid communication between the overfill channel 138 and the ambient environment. In embodiments, the main housing element 102 includes an outer surface 162, and the overfill port 136 extends through the outer surface 162.

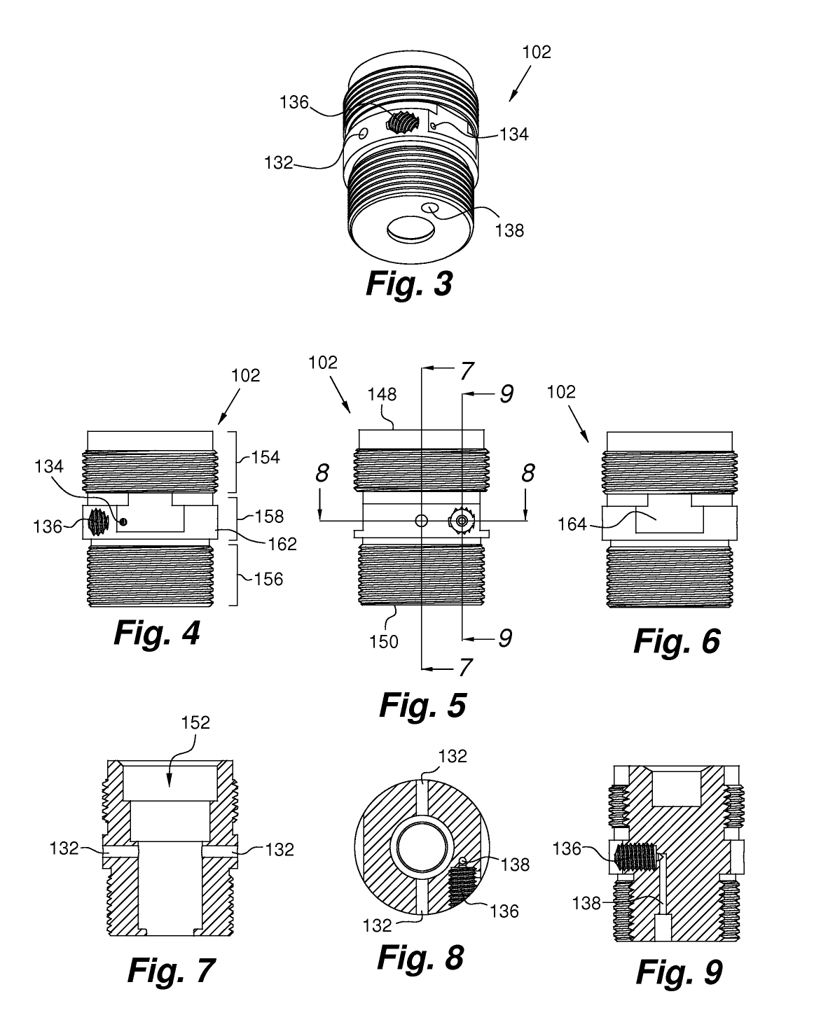

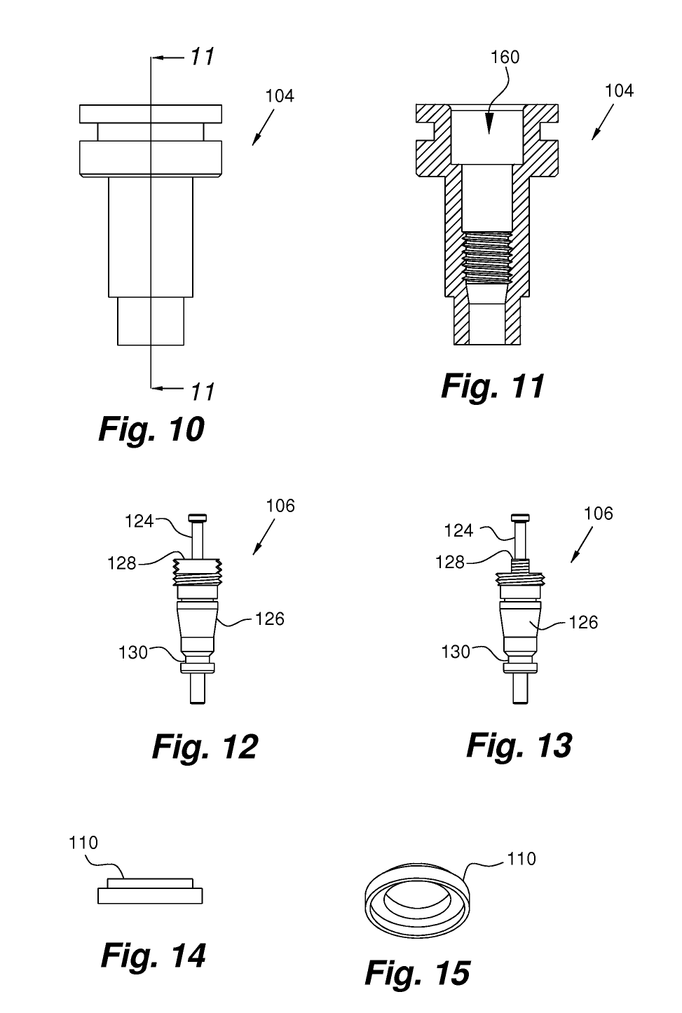

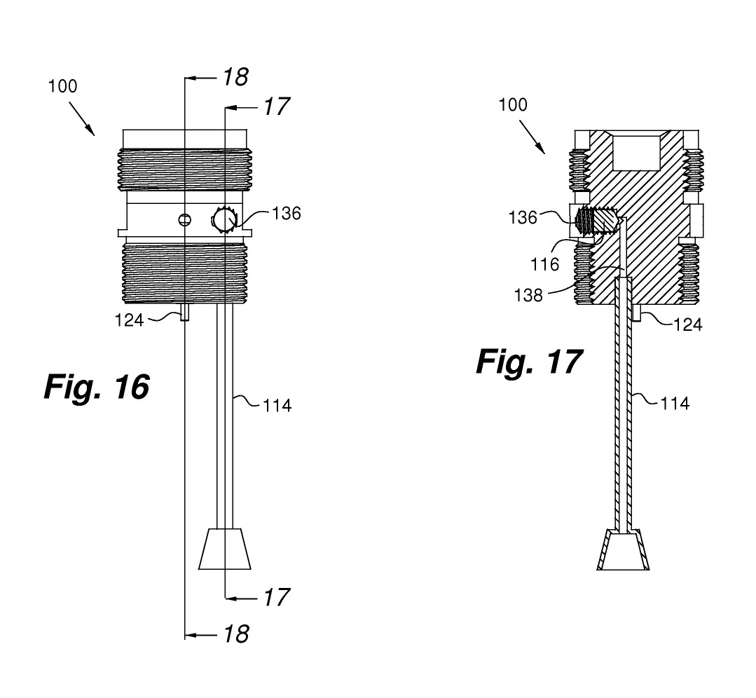

In embodiments which include an overfill port 136, the overfill port 136 may be adapted to threadedly engage a bleeder set screw 116. As illustrated, for example, in FIGS. 5 and 8, in further embodiments, the relief port 132 and the overfill port 136 may be located at approximately the same axial position along the main housing member. In particular embodiments, the overfill channel 138 may be adapted to engage a dip tube 114 member such that the dip tube member 114 extends generally outward of the distal end. Referring to FIGS. 3 and 17, the dip tube member 114 can extend down into the pressure tank, for example, as it is being filled with pressurized fluid. In such instances, when bleeder set screw 116 is sufficiently loosened, and the fluid in liquid form reaches the height of the free end of the dip tube member 114, the remainder of the liquid can be expelled through the overfill port and out the bleed port 134, generally as a result of the pressure within the pressurized tank.

Embodiments may be adapted to be particularly well suited to accommodate propane fittings such as, for example, a CGA600 limited standard cylinder valve outlet connection. Referring to FIG. 19 for illustration, in such an embodiment, the distance 166 between the proximal end 148 and the inlet end 170 of the piston member, may be approximately 0.718-0.675 inches to match the nipple length of the CGA600 fitting. In such an embodiment, diameter 168 may be approximately 0.66 inches to accommodate the flange diameter of the CGA600 fitting. Distance 166 and diameter 168 may be set to accommodate other industry-standard valve outlet connectors. In addition, the diameter of probe o-ring 118 is generally adapted to create a seal between the o-ring and the nipple of an outlet connection, when such a connection is threadedly connected to the valve assembly. For example, the nipple diameter in a CGA600 connection is approximately 0.185-0.193 inches. The inner diameter of O-ring 118 may therefore be set to approximately less than 0.185 inches to help ensure a proper seal between the nipple and the o-ring 118.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A combination valve assembly adapted to being mounted in a port in a pressure tank, the combination valve assembly comprising:
a pin valve element including a pin valve body and a piston member, the piston member being adapted to be slidably retained within the pin valve body, the pin valve element having an open configuration and a closed configuration, the pin valve element being elastically biased toward its closed configuration, the elastic bias being overcome responsive to a predetermined level of mechanical force axially applied to the piston member;
an insert shell element having an inner bore extending therethrough, the inner bore being adapted to threadedly receive the pin valve body;
a main housing element having a main bore adapted to receivingly engage the insert shell element so as to form an annular relief chamber, the main housing element having a proximal end, a distal end and a relief port therebetween, the relief port being adapted to be in fluid communication between the annular relief chamber and the ambient environment; and
a relief valve system having a relief configuration, a sealed configuration, the distal end being adapted to being in fluid communication with the annular relief chamber when the relief valve system is in its relief configuration, the relief valve system being resiliently biased toward its sealed configuration, the resilient bias being overcome responsive to a predetermined pressure at the distal end.

2. A combination valve assembly as defined in claim 1 in which the relief port extends generally radially outwardly of the main bore.

3. A combination valve assembly as defined in claim 1 in which the main housing member further has an overfill channel and an overfill port, the overfill channel being in fluid communication between the distal end and the overfill port, the overfill port being adapted to be in fluid communication between the overfill channel and the ambient environment.

4. A combination valve assembly as defined in claim 3 in which the main housing element includes an outer surface, and the overfill port extends through the outer surface.

5. A combination valve assembly as defined in claim 3 in which the overfill port is adapted to threadedly engage a bleeder set screw.

6. A combination valve assembly as defined in claim 3 in which the relief port and the overfill port are at approximately the same axial position along the main housing member.

7. A combination valve assembly as defined in claim 3 in which the overfill channel is adapted to engage a dip tube member such that the dip tube member extends generally outward of the distal end.
